(19) United States
(12) Patent Application Publication
(10) Pub. No.: US 2011/0315581 A1
(43) Pub. Date: Dec. 29, 2011

(54) Socket caddy

(76) Inventor: Henry E. Solowiej, Costa Mesa, CA (US)

(21) Appl. No.: 12/823,349

(22) Filed: Jun. 25, 2010

(51) Int. Cl. B25H 3/04

(52) U.S. Cl. 206/378

(57) ABSTRACT

A tent-shaped socket caddy with pins holding sockets by way of the force of gravity, substantially without friction with the pins. A base with a shallow storage box provides storage for socket ratchets and socket ratchet extensions.

### FIELD OF THE INVENTION

This invention relates to a socket caddy holding sockets and socket ratchets for use by mechanics.

### BACKGROUND OF THE INVENTION

Sockets and socket ratchets are widely used in various repairs, particularly in auto repairs. An auto mechanic would position himself under a vehicle and then reach for a toolbox in order to retrieve a socket ratchet or a socket to perform the repairs. This often has to be done “on the fly”, while using only one hand and while the hand is greasy. After use, a particular socket needs to be placed back for storage or replaced with a different socket, also “on the fly”, while using only one hand and while the hand is greasy. Most mechanics lack time or discipline to return a socket to a particular predetermined location and tend to just drop it into a tool box. Accordingly, there is a need to have a socket caddy providing easy and convenient access to sockets and socket ratchets, permitting removing and replacing sockets with one hand, quickly and with minimal effort. Further, an open view storage allows the user to determine whether there are any missing sockets at a glance.

### SUMMARY OF THE INVENTION

The socket caddy according to this invention satisfies this need. According to the first embodiment of this invention, a tent-shaped structure atop a base comprising storage is provided with pins extending at a substantially forty five degree angle to the base. Sockets are hung on the pins by way of the force of gravity without friction with the pins and thus can be easily removed and replaced with one hand. The second embodiment of this invention provides a vertical panel is atop a base comprising storage with pins extending at a substantially forty five degree angle to the base. As in the first embodiment, sockets are hung on the pins without the use of the force of friction.

### BRIEF DESCRIPTION OF THE DRAWINGS

FIG. 1 shows perspective and elevational views of the socket caddy according to the first embodiment of this invention.

FIG. 2 shows perspective and elevational views of the socket caddy according to the second embodiment of this invention.

FIG. 3 shows an alternative embodiment of this invention.

### DETAILED DESCRIPTION

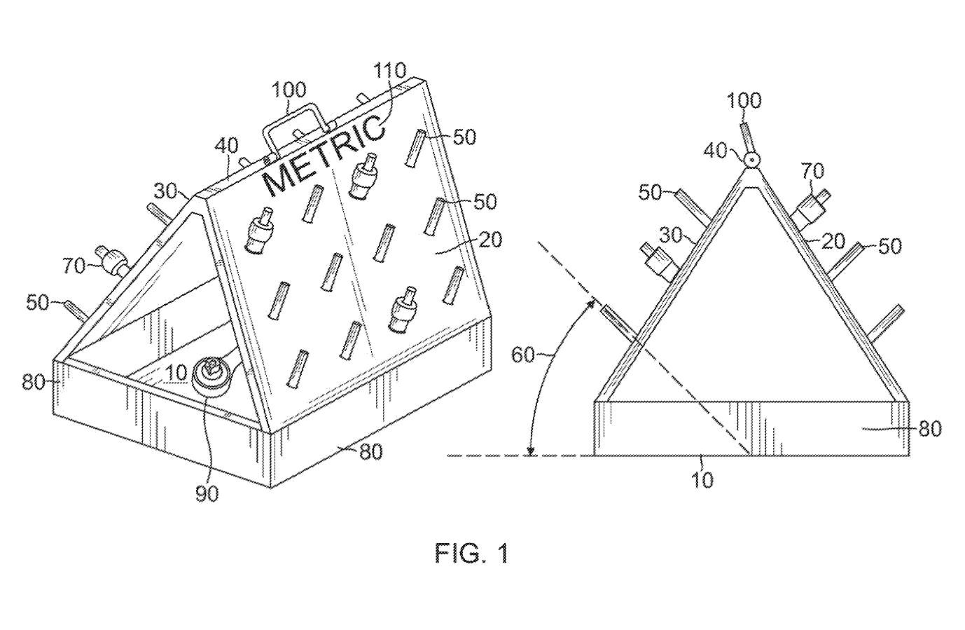

This invention will be better understood with the reference to the drawing figures FIG. 1 through 3. The same numerals refer to the same elements in all drawing figures.

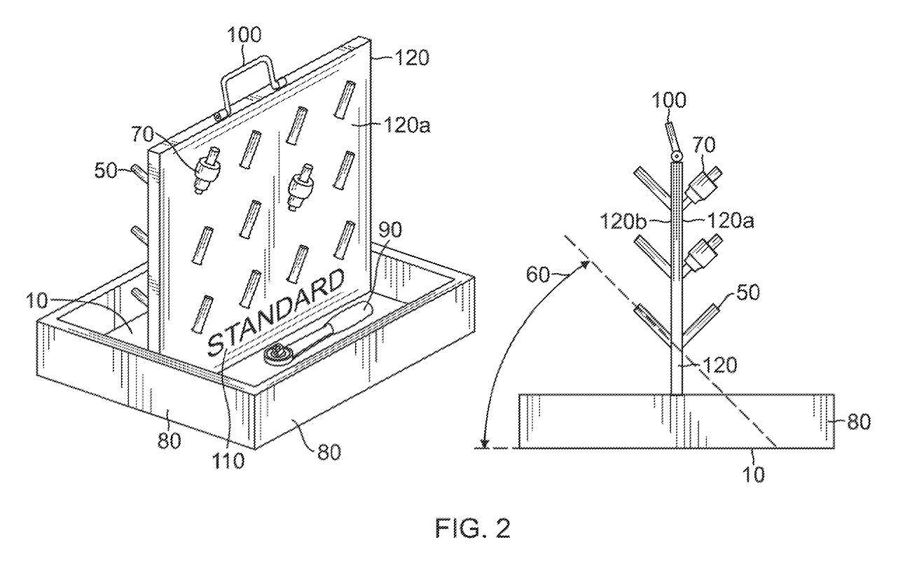

Viewing FIG. 1, numeral 10 indicates a base. Base 10 comprises a rectangular bottom panel with unequal dimensions and a longitudinal axis. In the preferred embodiment described in reference to FIG. 1 (as well as the embodiment described in reference to FIG. 2, as will be shown later), base 10 further comprises base walls indicated by numeral 80. Base walls 80 and the rectangular bottom panel of base 10 form a shallow box for storing socket ratchets and socket ratchet extensions indicated by numeral 90.

A first and second panels, indicated respectively by numerals 20 and 30, extend from base 10 and meet at a crest indicated by numeral 40. In the preferred embodiment shown in FIG. 1, first panel 20 and second panel 30 extend from tops of base walls 80, base walls 80 being a part of base 10. In different embodiments, first panel 20 and second panel 30 may extend directly from the rectangular bottom panel of base 10.

First panel 20 and second panel 30 form a tent having a conventional tent shape with a cross section, is in a plane perpendicular to crest 40, in the form of an inverted “V”. Crest 40 is parallel to the longitudinal axis of base 10. In the preferred embodiment shown in FIG. 1, a handle indicated by numeral 100 is disposed on crest 40. Handle 100 is for carrying the socket caddy according to this invention.

Numeral 50 indicates pins. A plurality of pins 50 extends from first panel 20 and second panel 30 at a predetermined angle indicated by numeral 60.

Numeral 70 indicates sockets. Pins 50 slidably and removably retain sockets 70 in a frictionless hanging arrangement by way of the force of gravity, permitting sockets 70 to be removed with one hand. To accomplish such frictionless hanging arrangement of pins 50, angle 60 must be between zero and ninety degrees with respect to the rectangular bottom panel of base 10. The objective of this invention is to provide effortless and quick removal and replacement of sockets 70 with one hand. Angles 60 smaller than zero degrees would cause sockets 70 to fall off of pins 50. Angles 60 larger than ninety degrees would make removal and replacement of sockets 70 difficult. The preferred embodiment described in reference to FIG. 1 shows angle 60 of forty five-degrees.

In the preferred embodiment described in reference to FIG. 1, base 10, first panel 20, second panel 30 and pins 50 are fabricated from a durable plastic material by way of injection molding. In other embodiments, base 10, first panel 20, second panel 30 and pins 50 may be fabricated from rigid metal, such as steel or aluminum, or wood. Numeral 110 indicates an indicia selected from the group consisting of standard and metric. Indicia 110 is disposed on first panel 20 and second panel 30, such that if first panel 20 comprises indicia “METRIC”, as shown in FIG. 1, second panel 30 would comprise indicia “STANDARD”. Standard and metric sockets are placed on either first panel 20 or second panel 30 accordingly. Indicia 110 can be applied either by injection molding or by way of an adhesive tape label.

Viewing now FIG. 2, numeral 120 indicates a vertical panel. Vertical panel 120 is fixedly attached to the rectangular bottom panel of base 10 along the longitudinal axis. Vertical panel 120 comprises a first and second faces indicated, respectively, by numerals 120a and 120b. Pins 50 extend from first face 120a and second face 120b at angle 60. As in the embodiment shown in FIG. 1, angle 60 is shown to be forty-five degrees with respect to the rectangular bottom panel of base 10. Similarly, in other embodiments, angle 60 must be between zero and ninety degrees with respect to the rectangular bottom panel of base 10.

In the preferred embodiment shown in FIG. 2, handle 100 is disposed on a top portion of vertical panel 120.

In the preferred embodiment described in reference to FIG. 2, base 10, vertical panel 120 and pins 50 are fabricated from a durable plastic material by way of injection molding. In other embodiments, base 10, vertical panel 120 and pins 50 may be fabricated from rigid metal, such as steel or aluminum, or wood.

Indicia 110 is disposed on first face 120a and second face 120b, such that if first face 120a comprises indicia “STANDARD”, as shown in FIG. 2, second face 120b would comprise indicia “METRIC”. Standard and metric sockets are placed on either first face 120a or second face 120b accordingly.

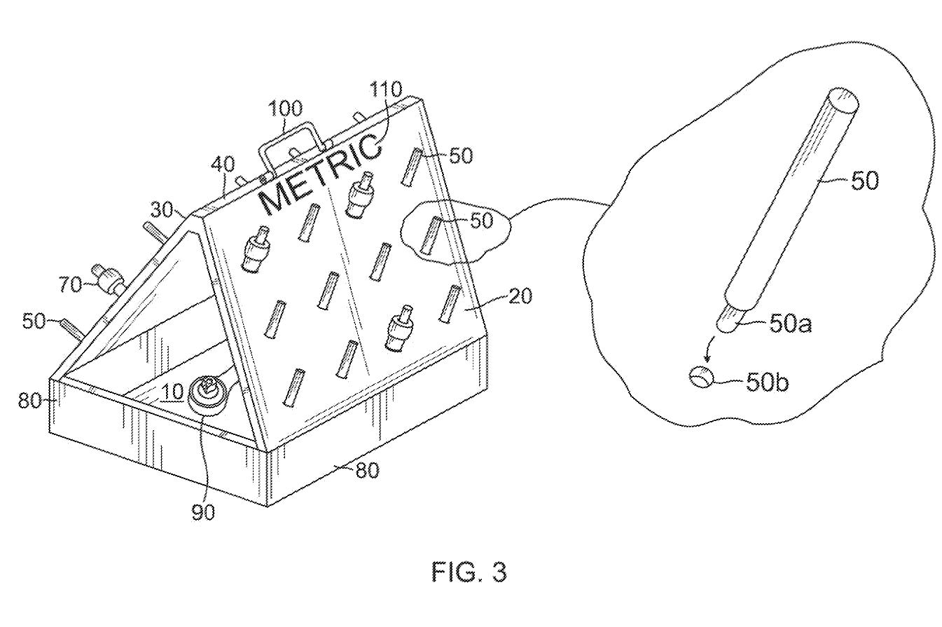

In the embodiments described in reference to FIGS. 1 and 2, pins 50 are not removable but are fabricated from a unitary piece of material with either first and second panels 20 and 30 or vertical panel 120. This can be accomplished, for example, by injection molding. It may be desirable to reduce manufacturing cost of the socket caddy according to this invention by having pins 50 removable, such that the user assembles the socket caddy himself by inserting pins 50 into either first and second panels 20 and 30 or vertical panel 120. FIG. 3 describes such removable pins 50 inserted into first and second panels 20 and 30. Removable pins 50 inserted into vertical panel 120 (not shown) work the same way.

Specifically, first and second panels 20 and 30 (as well as vertical panel 120) further comprise a plurality of openings indicated by numeral 50b. Openings 50b receive and removably retain pins 50. Pins 50 are frictionally press fit into openings 50b by the end user. This can be accomplished by way of a hammer.

The embodiment described in reference to FIG. 3 shows pin 50 as having a taper indicated by numeral 50a. Taper 50a is disposed on the end of pin 50 inserted into opening 50b. In this case, the diameter of opening 50b is slightly larger than the diameter of pin 50, allowing for press fitting of taper 50a into opening 50b. In other embodiments, pins 50 do not have tapers 50a, in which case openings 50b have diameters slightly larger than that of pins 50 for press fitting pins 50 into openings 50b.

While the present invention has been described and defined by references to the preferred embodiments of the invention, such references do not imply limitations on the invention, and no such limitations are to be inferred. The invention is capable of considerable modification, alteration, and equivalents in form and function, as will occur to those ordinarily skilled and knowledgeable in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

1. A socket caddy comprising:
a base comprising a rectangular bottom panel with unequal dimensions and a longitudinal axis;
a first and second panels extending from the base and meeting at a crest to form a tent, said tent having a conventional tent shape with a cross section, in a plane perpendicular to the crest, in the form of an inverted “V”, wherein the crest is parallel to the longitudinal axis;
a plurality of pins extending from the first and second panels at a predetermined angle between zero and ninety degrees with respect to said rectangular bottom panel, wherein the pins are for slidably and removably retaining sockets in a substantially frictionless hanging arrangement by way of the force of gravity, permitting sockets to be removed with one hand.

2. A socket caddy as in claim 1 wherein the base further comprising base walls, said base walls and the rectangular bottom panel forming a shallow box for storing socket ratchets and socket ratchet extensions.

3. A socket caddy as in claim 2 further comprising a handle disposed on the crest.

4. A socket caddy as in claim 3, wherein the predetermined angle between zero and ninety degrees is forty-five degrees.

5. A socket caddy as in claim 4, wherein the base, first and second panels and pins are fabricated from a material selected from the group consisting of durable plastic and rigid metal.

6. A socket caddy as in claim 5, wherein the first and second panels further comprise indicia selected from the group consisting of standard and metric.

7. A socket caddy as in claim 6, wherein the first and second panels further comprise a plurality of openings receiving and removably retaining the pins, the pins being frictionally press fit into the openings.

8. A socket caddy comprising:
a base comprising a rectangular bottom panel with unequal dimensions and a longitudinal axis;
a vertical panel comprising a first and second faces, the vertical panel fixedly attached to the rectangular bottom panel along the longitudinal axis;
a plurality of pins extending from the first and second faces at a predetermined angle between zero and ninety degrees with respect to said rectangular bottom panel, wherein the pins are for slidably and removably retaining sockets in a frictionless hanging arrangement by way of the force of gravity, permitting sockets to be removed with one hand.

9. A socket caddy as in claim 7 wherein the base further comprising base walls, said base walls and the rectangular bottom panel forming a shallow box for storing socket ratchets and socket ratchet extensions.

10. A socket caddy as in claim 8 wherein the vertical panel further comprising a handle disposed on a top portion of the vertical panel.

11. A socket caddy as in claim 9, wherein the predetermined angle between zero and ninety degrees is forty-five degrees.

12. A socket caddy as in claim 10, wherein the base, vertical panel and pins are fabricated from a material selected from the group consisting of durable plastic and rigid metal.

13. A socket caddy as in claim 11, wherein the first and second faces further comprise indicia selected from the group consisting of standard and metric.

14. A socket caddy as in claim 13, wherein the first and second panels further comprise a plurality of openings receiving and removably retaining the pins, the pins being frictionally press fit into the openings.
